(19) United States
(12) Patent Application Publication
(10) Pub. No.: US 2011/0217491 A1
(43) Pub. Date: Sep. 8, 2011

(54) LITHIUM OR BARIUM BASED FILM GETTERS

(76) Inventor: Konstantin CHUNTONOV, Nesher (IL)

(21) Appl. No.: 13/055,051

(22) Filed: Jan. 20, 2011

Related U.S. Application Data
(63) Continuation-in-part of application No. PCT/IL2009/000723, filed on Jul. 23, 2009.
(60) Provisional application No. 61/129,834, filed on Jul. 23, 2008.

(51) Int. Cl. B32B 1/02; H01J 7/18; B05D 3/04

(52) U.S. Cl. 428/34.1; 252/181.3; 252/181.4; 427/372.2; 427/383.1

(57) ABSTRACT

Two film materials, one of them with the structure of barium eutectic and another one with the structure of lithium solid solution, manufactured by thermal deposition. The mentioned films may give a freedom of choice of the sealing methods starting from the standard bonding processes with heating under vacuum to common gluing at room temperature.

### RELATED APPLICATIONS

This patent application is a continuation-in-part of PCT Application No. PCT/IL2009/00723, filed Jul. 23, 2009, (International Publication No. WO 2010/010563), which claims priority to U.S. Provisional Patent application No. 61/129,834, filed Jul. 23, 2008, the contents of which are hereby incorporated by reference in their entirety.

### FIELD OF THE INVENTION

The present invention generally relates to the field of film getters. More specifically, the present invention relates to getter films intended for usage in sealed-off long term vacuum chambers.

### BACKGROUND OF THE INVENTION

Many types of sealed-off vacuum devices use getters to increase their life-time. At this it is required that a getter should have high sorption capacity towards all leaking gases at normal temperatures.

There are two ways of increasing the sorption capacity of getter materials radically. In the case of transition metals, where only a near-surface region with the thickness of a few atomic layers takes part in gas sorption at room temperature, the sorption capacity of a getter mass can be increased by increasing the dispersion degree of the material. Thus, at transition from metallic powders of the commercial micron range to nanoparticles the intrinsic sorption capacity of the material grows approximately by three orders of magnitude.

However, metallic nanopowders tend to coalesce, besides, they are extremely reactive. For this reason in practice, e.g. in apparatuses for purification of gas streams from impurities getter mixtures or composites are used. These mixtures or composites consist of two substructures: coarsely dispersed porous bases, having metallic, ceramic, or even polymeric nature, and metallic nanopowders, mainly of Ni and Mn, covering the surface of the mentioned basis and partially filling its pores [Tamhankar S., Weltmer W. R. U.S. Pat. No. 4,713,224, Dec. 15, 1987; Weber D. K., Vergani G. U.S. Pat. No. 6,521,192, Feb.18, 2003; Zeller R., Vroman C. U.S. Pat. No. 7,112,237, Sep. 26, 2006; Alvarez Jr. D. U.S. Pat. No. 6,241,955, Jun. 5, 2001]. This solution ensures high degree of gas separation and at the same time has sufficient drawbacks, Volume fraction of nanoparticles, which are the main purification agent, is very low in these materials amounting to only a few percents; and the production technology of getter composites is very complicated, consists of many stages and takes a lot of time, from several tens to hundreds of hours [Watanabe T., Fraenkel D., Torres Jr. R. Pat. WO 03/037484, May 8, 2003]. Besides, the material is immediately destroyed at contact with the air.

A recent attempt to apply the described here composites to vacuum problems [Sparks D. R., Najafi N., Newman B. E. US Pat. Application, 20070205720, Sep. 6, 2007] looks natural, but no other ideas or experimental data about the structure or properties of the claimed getter material could be found in this paper. Therefore the negative remarks expressed towards gas purification composites are also valid here.

So, though increasing of the degree of dispersion of getter materials allows sufficiently increase of their sorption capacity, the really achievable values of the capacity appear to be rather far from the theoretical limit. As regards the production technology of getters with metallic nanoparticles, it is a high-cost one; and the price of the end product is very high accordingly.

Another way to increase sorption capacity of getter materials is to replace transition metals with chemically more active metals, alkali and alkali-earth, Gas sorption at room temperature takes place in this case by way of formation of a layer of products on the surface of the metal. This layer grows due to interdiffusion of the reagents till the metallic mass is completely exhausted. That is, these metals react with gases completely, providing maximally high sorption capacity.

However, high chemical activity of alkali and alkali-earth metals causes a lot of problems in handling them. Therefore until recently the only possibility of using these metals in the processes of chemical pumpdown of gases was the so called evaporable getters of a flash getter type, which released the vapor of the deposited metal only in an already evacuated and sealed device [Pirani M., Yarwood J. Principles of Vacuum Engineering, Reinhold Publ. Corp., N.Y., 1961, ch.6, pp. 251-291; Turnbull J. C., J. Vac. Sci. Technol., Vol. 14, No 1, 1977, 636-639].

The disadvantage of this kind of getters is well known—it is the necessity of large free surfaces inside the device. And though for some models of Image Tubes it is possible using design tricks to find the needed space, for example, in a form of a ring gap with the help of auxiliary shields [Thomas N. I. US Pat. Application 20070023617, Feb. 1, 2008], there is no such a possibility in devices like MEMS and FED.

Really new vistas for using active metals as getters in small vacuum devices opened up recently with the appearance of multilayer getter films, containing an interior active layer and an exterior protective layer [Kovacs A. L., Peter M. H., Ketola K. S., Linder J. F. U.S. Pat. No. 6,822,880, Nov. 23, 2004; Sparks D. R. U.S. Pat. No. 6,923,625, Aug. 2, 2005].

The first of these documents describes a Ti/Pd film. According to the given invention a layer of titanium deposited on the substrate and aimed at sorbing hydrogen is covered from outside with a layer of Pd, which easily lets hydrogen to titanium, but protects the latter from oxidation by the gases from the ambient atmosphere. This is certainly an elegant solution, but it refers to a particular problem—the problem of protecting of a GaAs circuity sealed in a hermetic package from hydrogen. Hydrogen is only one of gaseous species comprising residual gases, which include also O₂, CO, CO₂, H₂O, N₂, etc. and which should be also evacuated.

The second document, namely, [Sparks D. R. U.S. Pat. No. 6,923,625, Aug. 2, 2005], represents by itself the next step in the development of the idea of multilayer getter films. Here the exterior protective layer is preserved only as long as there is a necessity in conservation of the interior active layer. In order to switch the initial film into a working state, it should be heated either in an independent way or by receiving the heat from some concomitant process, e.g. from the operation of sealing the device, which is usually performed at the temperature from 300° to 500° C. As the author of U.S. Pat. No. 6,923,625 believes, the atoms of the inner layer manage to diffuse through the outside layer during the time of sealing and to come to its surface in order to implement their getter functions after that.

U.S. Pat. No. 6,923,625 contains a description of two methods of building up film structures, which can be schematically written down as combinations Sub/A/N and Sub/N/A/N, where Sub is a substrate, which is usually glass, silicon, or ceramics, A is layer of a component selected from the ensemble of chemical elements, which the author of the cited patent referred to reactive ones, N is a layer of the component, selected from the rest of the chemical elements (excluding inert gases), which the author called nonreactive.

At this, the second, three-layered, combination is foreseen for the case, when during the treatment the substrate is removed and then the remaining sandwich—like film N/A/N itself provides chemical protection for the layer A from the environment.

There is no doubt that following the prescriptions of U.S. Pat. No. 6,923,625 it is possible to obtain several high quality getter films of different compositions.

However, it is also possible to assert that the degree of generality, which this patent claims for, has no grounds.

Thus, accepting the suggested in U.S. Pat. No. 6,923,625 borderline between reactive A and not reactive N and also fulfilling all the necessary for it operations, one could try producing double layer films
Sub/Li layer 400 nm thick/Ag layer 30 nm thick
   or
Sub/Ba layer 400 nm thick/In layer 20 nm thick,
   which after heating in vacuum to any temperature in the interval 300-500° C. would give a superactive getter product of the composition Li—8.8 at % Ag or Ba—11 at % In accordingly. However, in practice the result of heating of Li—containing film will be a partial lost of Li due to evaporation and chemical disintegration of the substrate Sub if it is made of glass, ceramic of silicon [Borgstedt H. U., Mathews C. K. Applied Chemistry of Alkali Metals, Plenum Press, N.Y., 1987;—Moissan, C. r. Acad. sci., Paris, 134 (1902) 1083].

Exactly in the same way in the case of Ba-containing film the process of mixing the components at raising the temperature to 300-500° C. will not go the way of formation of the equilibrium mixture of crystals Ba₁₃In and Ba₂In but as the experience shows will take the form of the fast reaction of synthesis of a stable to gases intermetallic compound BaIn₄

$$nBa ( s ) + 4 In ( l ) {}^{T} ( n - 1 ) Ba ( s ) + {BaIn}_{4} ( s ) + Δ H ,$$

the particles of which will cover the surface of solid Ba. Here (s) an (l) indicate an aggregative state of a component, solid and liquid correspondingly and ΔH is a thermal effect of the reaction.

And that is not all, there are other variants of the behavior of films A/N, which do not fit into the concept of U.S. Pat. No. 6,923,625 about the diffusion mechanism of the interaction of the layers A and N. However, even if we limit ourselves to A/N systems with fusible components, the number of which amounts to several hundreds, they are enough for the conclusion about the falsity of the methodic guidelines of U.S. Pat. No. 6,923,625 following from the incorrect demarcation of the elements A and N.

So, the technology of multilayered getter films develops intensively. However, this development is going in the direction of transition metals, while only chemically active metals are able to increase the lifetime of the sealed of vacuum devices radically. The attempt to give a general method of producing any kind of getter films including those with a chemically active component undertaken in U.S. Pat. No. 6,923,625 appeared to be unsuccessful.

Below a number of getter films with high concentration of active metal and methods of production of these films are described. The films are intended for long term maintenance of vacuum in small sealed-off devices.

### SUMMARY OF THE INVENTION

The present invention is a reactive film getter. According to some embodiments of the present invention, two or more metals having substantially dissimilar gas sorption selectivity and rate characteristics may be adapted to provide mutual complementary gas sorbent abilities. According to some embodiments of the present invention, films may be produced on the basis of alloys containing Ba or Li as one of the components and some metal from the group of Al, Mg, or Pd as the other component.

According to some embodiments of the present invention, the layers may be alternately deposited onto a “hot” substrate, after which the last layer may deposited on the cooled film. The total thickness of the deposited film may be determined by the planned lifetime of the device. The films may be deposited on an inner wall of the vacuum chamber of the device and/or on a suitable metallic strip introduced into the device and afterwards fixed inside at the stage of its assembly.

According to the mentioned in [009] problem of high chemical activity of reactive metals is solved due to passivation effects. For Ba-containing films such a solution is deposition of an Al or Mg coating on the mentioned film. This coating passivates during its exposure to the air protecting the inside layers of the film from erosion. In the case of Li-containing films this kind of a solution is to use as a getter solid solutions of lithium, the sorption behavior of which can be characterized by the term quasi-passivation: at the contact of these films with the air their sorption rate abruptly decreases remaining, however, high enough to maintain vacuum in a sealed chamber.

According to the present invention, Ba-containing getters consist of eutectic films Ba—(28.5±2.5) at % Al or Ba—(35±5) at % Mg obtained by multiple alternate deposition of thin layers of Ba and Al or Mg onto a heated to 200±50° C. substrate with the deposition of a protective Al or Mg coating onto the film at the temperature below 0° C. These getters require thermal activation by heating to the temperature not higher than 250° C. in the case of Mg-containing films and not higher than 350° C. in the case of Al-containing films.

According to eutectic barium getters are deposited either directly onto the suitable metallic substrate or onto another substrate, e.g., glass, silicon, or ceramics, the surface of which is preliminarily metalized by depositing on it a thin layer of Cr or Mn.

According to the present invention, Li-containing getters of the composition Lix Pd1-x , where 0.48≦x≦0.54 or 0.25≦x≦0.40 are obtained by multiple alternate deposition of thin layers of Li and Pd onto a heated to 200±500C during the entire process. These films are stable to a short exposure to the air and do not need reactivation. Therefore the assembly of the vacuum device and its sealing can be performed at room temperature with the employment of the corresponding sealing materials.

According to the present invention, Li-containing films can be deposited on the suitable metallic substrate, e.g., stainless steel, nichrome, molybdenum, etc., or on silicon, glass or ceramics coated by a thin layer of Cr or Mn.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1a is a drawing of an exemplary Sorption Mechanism, in accordance with some embodiments of the present invention;

FIG. 1b shows Sorption Kinetics graphs, for exemplary Sorption Mechanisms, in accordance with some embodiments of the present invention;

FIG. 2 is an exemplary graph, of the Growth of Products on the Surface, in accordance with some embodiments of the present invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

Unless specifically stated otherwise, as apparent from the following discussions, it is appreciated that throughout the specification discussions utilizing terms such as “sorbing”, “gettering”, “reacting with”, or the like, refer to the action and/or processes of a metal based getter or getter system, or similar chemical device, that may provide gas sorbent abilities.

Embodiments of the present invention may include apparatuses for performing the operations herein. Such apparatus may be specially constructed for the desired purposes, or it may comprise a general-purpose system that may be selectively activated or reconfigured.

The processes and displays presented herein are not inherently related to any particular system or apparatus. Various general-purpose systems may be used in accordance with the teachings herein, or it may prove convenient to construct a more specialized apparatus to perform the desired method. The desired structure for a variety of these systems will appear from the description below.

According to some embodiments of the present invention, the problem of designing of film getters comes down therefore to a rational selection of sorption partners, which is easier to realize in the case, when one of them belongs to the group of universal gas sorbents, which are Ba and Li, and another one is taken from a group of such getter metals as Al, Mg, or Pd.

In the present invention two methods of combining Ba or Li with Al, Mg, or Pd are used in a way that the principle of additivity is being fulfilled:
(a) films of eutectic composition;
(b) films of solid solutions of lithium in an intermetallic matrix.
   To achieve the highest sorption effectiveness the components of the getter materials are selected in such a way that at the stage of their assembly in the device they create convenience in handling of the films and during the operation of the device both components complement each other in sorption respect.

According to some embodiments of the present invention, films may be produced by multiple and alternate deposition of layers A₁/A₂/A₁/A₂/ . . . A₁/A₂, where A₁ is Ba or Li, A₂ is Al, Mg or Pd (by using the notations of A₁ and A₂ for manifold layers of the film getter we emphasize that as opposed to U.S. Pat. No. 6,923,625 in our case both components participate in sorption under vacuum conditions) deposition rate is determined by the nature of the system A₁-A₂. The deposition is performed varying in the range of 0.01-10 A/s onto a suitable substrate, heated to 150-250° C. as it is schematically shown below

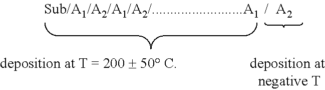

According to some embodiments of the present invention, this kind of substrate may be stainless steel, nichrome, molybdenum and other metals. In the case, when the substrate is ceramics, glass or silicon, they should be preliminarily metallized by covering, e.g. with a thin Cr or Mn film.

According to some embodiments of the present invention, the thickness of a single paired layer A₁/A₂ , if alternate deposition is performed, may be no more than 50 nm and the ratio between the thicknesses of the layers A₁ and A₂ inside such a paired layer must correspond to the general ratio between the components A₁:A₂ in the synthesized product. This technique is taken from the technology of production of alkali photocathodes [Sommer A. H. Photoemissive Materials, John Willey & Sons, N.Y., 1968] and used for getter films to obtain an equilibrium product and to avoid loose particles formation

According to some embodiments of the present invention, the films may be deposited both on an inner wall of the vacuum chamber of the device and on a suitable metallic strip introduced into the device and afterwards fixed inside the device at the stage of its assembly. Depending on the type of a vacuum device films of different compositions can be employed including films of BaₓAl₁₋ₓ, where 0.69≦x≦0.74, BaₓMg₁₋ₓ, where 0.6≦x≦0.7, and also LiₓPd₁₋ₓ, where 0.25≦x≦0.40 or 0.48≦x≦0.54. These films intensively sorb all active gases at room temperature.

According to some embodiments of the present invention, as the above listed films contain volatile metals, temperature limitations appear for the processes of sealing these devices under vacuum: for Ba—Mg films the maximum heating temperature may be 250° C., for Ba—Al films it may be about ˜350° C., for Li—Pd films about ˜400° C. However, the substantially high sorption capacity of the given films may allow avoiding these limitations with the help of low-temperature sealing materials (i.e. materials performing bonding or gluing at the temperature from room one to ˜150° C.) if the temperature of their softening (unbrazing) is higher than 250° C.

In this case a short heating of the device to 200-250° C. after the bonding or gluing operation may allow completing the activation of the getter film. Moreover, when using Li—Pd films even this heating may not be needed: the sealing can be done at room temperature.

According to some embodiments of the present invention, obtained by the disclosed above method Ba—Mg, Ba—Al and Li—Pd films may represent by themselves new effective getters with substantially high utilization factor of the material: both components of the film may participate in reactions with residual gases at room temperature and the reactions themselves at this may proceed to the end. The process of production of this kind of getter films may consist of repeated deposition of thin double layers A1/A2 on a heated substrate, which provides the formation of a product, close to equilibrium, having relatively high mechanical stability and good adhesion to the substrate. Insertion of these getters into small sealed off vacuum devices may allow increasing their lifetime by tens of times.

(a) Films of Ba—35 at % Mg or Ba—28.5 at % Al, as well as films with small deviations from the mentioned composition in both directions refer to eutectic type. The structure of these films can be considered as a mixture of phases Ba and BaMg₂, each of which behaves in sorption respect independently from each other. Like other fine-grained structures eutectic is characterized by a developed net of grain boundaries, which serve as the channels for a rapid migration for gases and the metallic diffusant, maintaining the kinetics of the sorption process on a high level.

(b) Intermediate phases LiPd and LiPd₂ as shown in [Loebich O., Raub Ch. J. Platinum Metals Rev., 25 (1981) 113] have the homogeneity range from 46 to 52 at % Pd for the first one and from 60 to 75 at % Pd for the second one [Loebich O., Raub Ch. J. Platinum Metals Rev., 25 (1981) 113]. According to the present invention these phases are the representatives of the new getters of the activationless type. Activationlessness here is understood in the narrow sense, that the getter sorbs gases at room temperature without the customary activation heating even if it was already exposed to the air. This is the wonderful feature possessed also by solid solution of Li in some noble metals, e.g. in Ag, Au, Cu or in their intermetallic compounds.

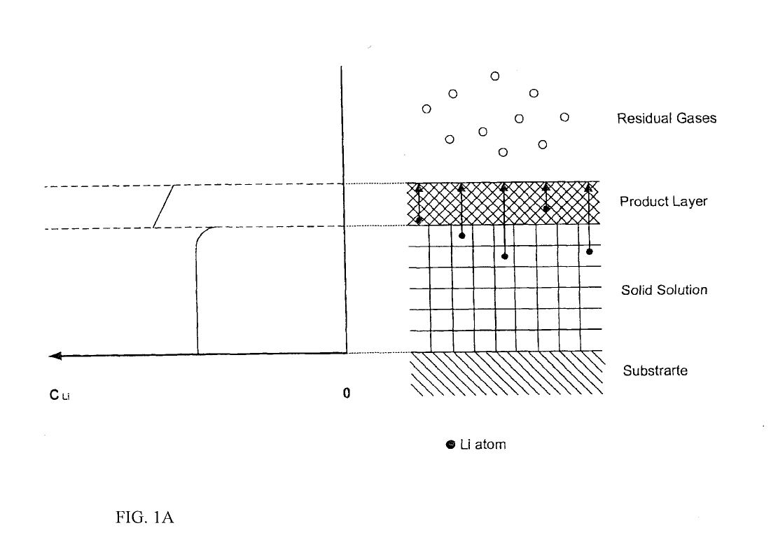

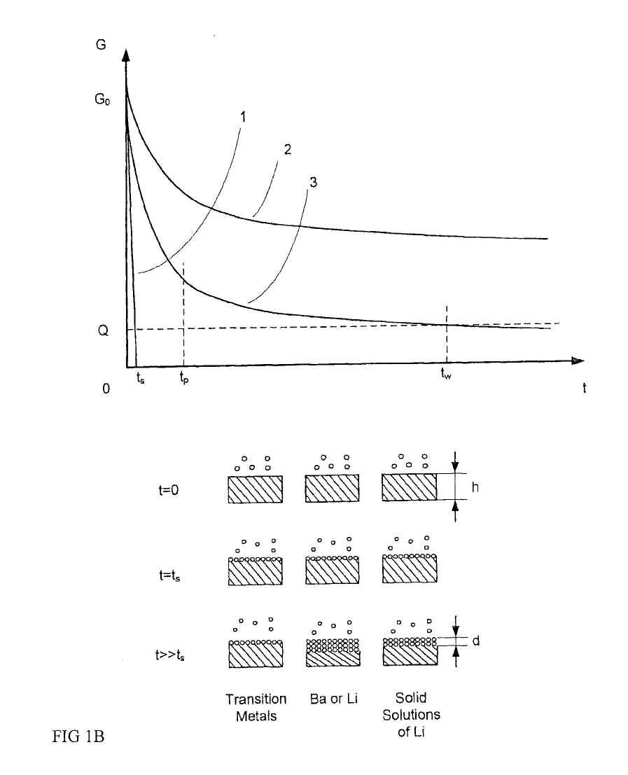

As—deposited LiPd_{0.86} or LiPd_{1.5} films at the initial stage of reactions with the residual gases, i.e. at t<tₚ, are covered with a thin layer of products, mainly lithium oxides, several nanometers thick (FIG. 1a, b). After this the reaction passes into the next stage, where the transfer of Li atoms from the film to the layer of products becomes a limiting process for the gas sorption. As a result the rate of capturing gases by the getter film abruptly slows down and under the normal conditions this is taken for the phenomenon of passivation of the material.

It is important, however, that even in this passivated state Li solid solutions maintain comparatively high rate of gas sorption, and are able therefore to withstand the flow of leaking gases from outside for a long time. It is this sufficiently high sorption rate together with the big sorption capacity that allows simplifying the technology assembly and sealing of small vacuum devices performing the mentioned operations under the temperatures as low as room temperature

Sealing of the device not at 300-500° C., but at room temperature has certain advantages:
there is no need in vacuum or heating equipment, which simplifies and reduces the price of the sealing procedure; and
the sorption resource of the getter is saved due to the “freezing” of the processes of volume outgassing of the inside parts and walls of the vacuum chamber.

Opposite to traditional bonding processes, when the dissolved in the device walls gases are released at heating and poison the getter, the volume outgassing does not take place during the cold sealing process and all the dissolved gases remain inside the material maintaining strong chemical bonds with it. The following spontaneous outgassing of the sealed device during its operation creates in this case the regime of small gas leakage, which provides the most effective work of the getter film and the corresponding increase of the lifetime of the device [Chuntonov K, et al., Vacuum, 85 (2011) 755-760].

Gas sorption by LiPd and LiPd2 films proceeds in the following way. The surface Li atoms react with all active gases except hydrogen forming chemical compounds, the growth of which on the surface is supported by the diffusion of Li atoms from the volume of the film. At the same time hydrogen dissolves in the matrix of the intermetallic compounds of LiPd and LiPd2 [Sakamoto Y., Nakamura R., Ura M., J. Alloys Compd., 231(1995)553] or in the in the islands of metallic palladium formed in the intermetallic matrix after Li atoms go away.

According to some embodiments of the present invention, the chemical composition of the getter material, may be one of the technical characteristics of the product. The other important characteristics may be the structure of the material and its dimensional parameters.

According to some embodiments of the present invention, for the continuous getter films their thickness is the dimensional parameter, and the thickness is directly connected with the usage coefficient of the getter material, in other words, with the relative sorption capacity of the getter Cᵣ, which can be defined as a ratio of the amount of the metal atoms really participating in sorption to the total amount of capable of sorption metal atoms.

According to some embodiments of the present invention, the issue of the getter films thickness may be solved with the help of the formal analysis of the sorption kinetics. Thus, in the case of transition metals the sorption rate is described by Elovich equation [Adamson A. W. Physical Chemistry of Surfaces, John Wiley & Sons, New York, 1982]. If the processes of tens and hundreds of thousands of hours are discussed, then on this time scale the curve G(t) for the transition metals will be the line segment (FIG. 1b) going from the initial point G₀ upright down to the point tₛ, which is located close to the origin of coordinates (curve 1). At t=tₛ any metallic surface appears to be covered with a monolayer of gases, which for transition metals corresponds to the saturation state (FIG. 1b).

It follows herefrom, that it would be efficient to use monoatomic getter films of transition metals. However, during the installation of a getter film into a vacuum device it inevitably passivates and for this reason it has to be activated later on. In order that in the end of the activation practically the complete cleaning of the surface is achieved, the film should be about 300 nm thick, taking into consideration the limited solubility of gases in it. The value of Cᵣ in this case is equal to ˜0.1% and becomes still smaller with the increase of the getter film thickness.

According to some embodiments of the present invention, gas sorption by Ba—(28.5±2.5) at % Al and Ba—(35±5) at % Mg films follows the parabolic law (curve 2) and even at very big times t the rate of capturing all active gases is high. As far as the reaction with gases lasts to complete exhaustion of the material, the thickness of the getter film is easy to calculate for each concrete application basing on the data about the gas leakage rate Q (FIG. 1b) and the planned lifetime of the device.

According to some embodiments of the present invention, the behavior of Li solid solutions (curve 3) can be understood from the point of view of the classical theory of metal oxidation [Hauffe K. Reaktionen in and an festen Stoffen, Springer-Ferlag, Berlin, 1955], but still this is a new case, differing from the previously studied schemes by the following peculiarities: a very low density of gas medium (vacuum conditions), high mobility of the diffusant in the alloy, and a big value of the ratio Du_{Li+}/D_{Li}>>1, where D_{LI+} is a diffusion coefficient of Li⁺ cations in the layer of products and Du is a diffusion coefficient of Li atoms in the alloy. All this taken together leads to an unusual shape of the curve 3, where two different branches may be singled out: the one, which is fast falling in the time interval [0, tₚ) and another one at t>tₚ, when the sorption rate more or less stabilizes.

According to some embodiments of the present invention, the getter film maintains the operation of the vacuum device till G>Q (FIG. 1b). Therefore the intersection point of the curve 3 with the line Q determines the lifetime of the device, i.e. the value of t_{w}. Knowing t_{w} it is easy to find the optimal thickness of the getter film for solid solutions of Li.

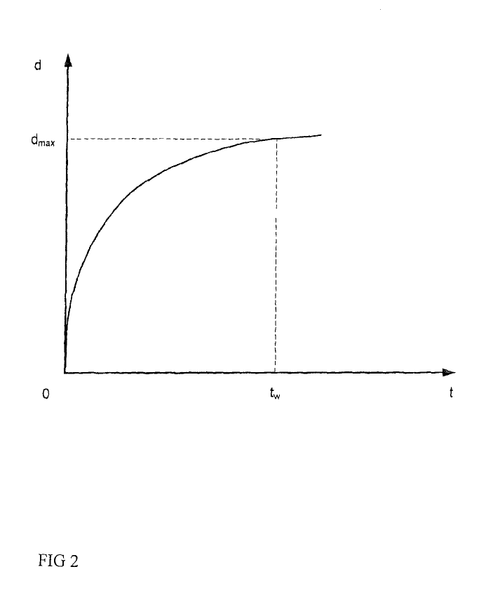

FIG. 2 shows the curve d=d(t), where d is the thickness of the layer of products, formed on the surface of the getter film by the moment of time t>>tₛ(FIG. 1b). This curve is the result of integration of G=G(t) with respect to t and the further transformation of the obtained dependence C=C (t) into the dependence d=k C (t), where C is the amount of gases captured during the time t and k is the proportionality factor. As is seen from FIG. 3 at t=t_{w} the layer of products reaches the thickness of dₘₐₓ and this thickness dₘₐₓ with the sufficient for the practical purposes accuracy coincides with the thickness of the getter film h (FIG. 1b), at which Cᵣ→1 and also the lifetime of the device is maximum.

With the appearance of the reliable method of tracing curves 3 [Chuntonov K., Ivanov A., Permikin D. J. Alloys and Compounds, 471 (2009) 211-216] the problem of finding the optimal film thickness h may became easy to solve, since the gas leakage rate Q is usually known.

Thus, the new getter films based on lithium or barium due to the usage of the passivation effects are easily compatible with the existing technologies of assembly and sealing of small vacuum devices. Furthermore, due to the rational selection of the technical parameters of the product, the composition of the getter film and its thickness, it is possible to bring the sorption capacity of these films substantially close to the theoretical limit, excelling in this respect the modern getter films based on transition metals by around 100 times or more.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

### DETAILED DESCRIPTION OF THE DRAWINGS

FIG. 1a An exemplary mechanism of gas sorption by solid solutions of Li. For the better understanding of the sorption mechanism a cross section of the getter film is shown on the right and the distribution of lithium concentration c_{Li} in this film for a certain moment of time t≠0—on the left. Li diffuses from an alloy of “LiPd” or “LiPd₂” through a layer of products to the boundary with gases, where the growth of this layer takes place due to the reaction of Li atoms coming from the volume of the film with gases O₂, N₂, CO, etc. Hydrogen, on the contrary, diffuses from the gas phase through the layer of products to the boundary with the alloy and further on dissolves in it.

FIG. 1b Shows exemplary graphs of the dependence of sorption rate on time at room temperature for getters of different types.

G is the sorption rate, i.e. the amount of gases sorbed by an area unit during a time unit, G₀ is the sorption rate at t=0, Q is the leakage rate through the chamber wall, t is time, h is the thickness of the getter film, d is the thickness of the products layer, 1 is the sorption curve for the films of transition metals, 2 is the sorption curve for the films of Li—(3.5±1.5) at % Mg or barium eutectics, 3 is the sorption curve for Li solid solutions.

The curve 3 has two arms: in the beginning, at t<tₚ, the process involves a very thin surface layer of the material running practically diffusionlessly. This stage finishes at t≈tp , when a layer of products growing on the surface is a few nm thick. Then at t>tₚ a diffusion stage takes place. It can be described with the help of a term quasi passivation: the appearance of a layer of products on the surface of the getter film slows down but does not stop the sorption process. This makes Li solid solutions so valuable. On the one hand, the layer of products protects the lithium material from destruction at a sudden contact with the air, on the other hand, the sorption rate up to the point t=t_{w} exceeds the leakage rate Q maintaining the vacuum device in the working state.

FIG. 2 Shows an exemplary graph of the dependence of the thickness of the growing products layer on time.

d—the thickness of the products layer, t—time, dₘₐₓ—the thickness of the products layer by the end of the operational time, i.e. by the moment t=t_{w}. Assuming for the deposited film the thickness h equal to dₘₐₓ, we by doing so create the conditions for the most economical usage of the getter material, i.e. conditions for Cᵣ→1 (if h<<dₘₐₓ, then Cᵣ→1, but the lifetime is very short, if h>>dₘₐₓ, then though the lifetime is maximum but Cᵣ<<1).

What claimed is:

1. A film getter device comprising:
two or more layers of a Ba—Al composition;
a coating layer of Al, coating said two or more layers; and
a substrate, which is protected by a barrier layer of Cr.

2. The film getter device according to claim 1, wherein:
the barrier layer is made of Mn.

3. The film getter device according to claim 1, wherein:
the substrate is metallic and has no barrier layer.

4. The film getter device according to claim 1, wherein:
the two or more layers are of a Ba—Mg composition; and
the coating layer is of Mg.

5. The film getter device according to claim 4, wherein:
the substrate is metallic and has no barrier layer.

6. A film getter device comprising:
a thin metallic strip;
a Li composition with a thin Mg-coating and a Ti composition film with a thin Ag or Pd-coating; and
wherein, each of said compositions covers another side of said metal strip.

7. The film getter device according to claim 6, wherein:
the Ti composition film is replaced by a V film with a thin Au or Pd-coating.

8. A method of production of film getters, comprising:
alternately depositing layers of two different reactive gas sorbent components
on a substrate;
wherein the last layer deposited also acts as a cover layer.

9. The method according to claim 8, wherein:
The first reactive gas sorbent component consists of Ba; and
The second reactive gas sorbent component consists of one metal selected from a set consisting of Al, Mg or Pd.

10. The method according to claim 9, wherein:
the first reactive gas sorbent component consists of Li.

11. The method according to claim 8, further comprising:
heating the substrate to a temperature of 150-250° C. for the duration of the deposition of the layers; and
cooling the film to a negative temperature for the duration of the deposition of the cover layer.

12. A film getter device comprising:
one or more layers of a LiPd composition;
a coating layer of Pd, coating said one or more layers; and
a substrate, which is protected by a barrier layer of Cr, wherein:
said substrate is especially allotted for a deposition area inside a vacuum chamber.

13. The film getter device according to claim 12, wherein:
the substrate is protected by a barrier layer of Mn.

14. The film getter device according to claim 12, wherein:
the one or more layers are deposited on a metallic substrate without a barrier layer.

15. A method of capturing residual gases in small sealed-off devices using:
a film getter device comprising:
two or more layers of a Ba—Al composition;
a coating layer of Al, coating said two or more layers; and
a substrate, which is protected by a barrier layer of Cr.

16. A method of capturing residual gases in small sealed-off devices using:
a film getter device comprising:
two or more layers of a Ba—Al composition;
a coating layer of Al, coating said two or more layers; and
a substrate, which is protected by a barrier layer of Mn.

17. A method of capturing residual gases in small sealed-off devices using:
a film getter device comprising:
two or more layers of a Ba—Al composition;
a coating layer of Al, coating said two or more layers; and
a metallic substrate.
